(19) United States
(12) Patent Application Publication
(10) Pub. No.: US 2013/0147369 A1
(43) Pub. Date: Jun. 13, 2013

(54) LED LIGHT STRING AND LED MODULE WITH AN INTEGRATED SIGNAL CONTROLLER THEREOF

(71) Applicant: Cheng-Chun ZHANG, Kaohsiung City (TW)

(72) Inventor: Cheng-Chun ZHANG, Kaohsiung City (TW)

(73) Assignee: GEMMY INDUSTRIES CORPORATION, Coppell, TX (US)

(21) Appl. No.: 13/324,312

(22) Filed: Dec. 13, 2011

(51) Int. Cl. H05B 37/02

(52) U.S. Cl. 315/185 R; 315/363

(57) ABSTRACT

An LED light string has multiple LED modules connected in series and a control device connected to the LED modules. Each LED module has a pin assembly, at least one LED chip and a signal controller. The pin assembly has a substrate and multiple pins. The multiple pins include a first power pin, a second power pin, a first signal pin and a second signal pin. The substrate is formed on a top end of the first power pin. The LED chip and the signal controller are mounted on the substrate. The pin assembly, the at least one LED chip and the signal controller are electrically connected to each other. Because the signal controller is integrated in the LED module, the signal controller receives a control signal to activate the LED chip directly.

### BACKGROUND OF THE INVENTION

1. Field of the Invention

The present invention relates to an LED light string and an LED module thereof, and more particularly to an LED light string and an LED module with an integrated signal controller thereof.

2. Description of Related Art

An LED (light emitting diode) device is a light-emitting component. When a controller electrically connects to the LED device, the controller provides a driving voltage and a control signal to activate the LED device.

Multiple LED chips can be mounted together to form an LED module. For example, a red LED chip, a green LED chip and a blue LED chip form an LED module. By adjusting the driving voltage, the LED chips are able to produce various colors by mixing different lights.

The controller is applied to provide the driving voltage to the LED device or the LED module. The LED device or the LED module has to be electrically connected to the controller. If an electric product has multiple LED devices or LED modules, such as an LED string, each of the LED devices or LED modules will require a separate controller. All the controllers must be mounted near the LED devices or LED modules in accompaniment. Therefore, the controllers occupy a large space in the electric product.

### SUMMARY OF THE INVENTION

An objective of the present invention is to provide an LED light string and an LED module thereof. An integrated signal controller is integrated in the LED module. Therefore, a space occupied by the LED module in accordance with the present invention in an electric product will decrease effectively.

To achieve the foregoing objective, the LED module with an integrated signal controller comprises a pin assembly, at least one LED chip, a signal controller and a package.

The pin assembly has a substrate and multiple pins. Each pin has a top end and the multiple pins include a first power pin, a second power pin, a first signal pin and a second signal pin. The substrate is formed on the top end of the first power pin. The at least one LED chip is mounted on the substrate and electrically connected to the substrate. The signal controller is mounted on the substrate and electrically connected to the first power pin, the second power pin, the first signal pin and the second signal pin to provide at least one driving signal to the at least one LED chip. The package is formed to securely enclose the substrate, the at least one LED chip, the signal controller and the top ends of the multiple pins.

The LED light string has a plug, a control device and multiple LED modules mentioned above. The control device is electrically connected to the plug and has a voltage terminal and a signal output terminal. The voltage terminal of the control device is connected to the first power pins and the second power pins of the LED modules, and the signal output terminal of the control device is connected to the first signal pins and the second signal pins of the LED modules.

The first power pin and the second power pin electrically connect to the control device. When the control device provides a control signal to the signal controller, the signal controller decodes the control signal and then generates the driving signal to activate the LED chip.

Because the signal controller is integrated in the LED module, a space occupied by the LED module in accordance with the present invention decreases. Therefore, an electric product with multiple LED modules in accordance with the present invention does not have to provide spaces to mount the signal controllers. The volume of the electric product is able to decrease.

### BRIEF DESCRIPTION OF THE DRAWINGS

FIG. 1 is a perspective view of the LED module in accordance with the present invention;

FIG. 2 is a top view of the LED module in accordance with the present invention;

FIG. 3 is an enlarged plan view in partial section of the LED module in accordance with the present invention;

FIG. 4 is a block diagram of the signal controller of the LED module in accordance with the present invention;

FIG. 5 is an enlarged cross-sectional view in partial section of the LED module in accordance with the present invention;

FIG. 6 is an initial structure of the pin assembly of the LED module in accordance with the present invention;

FIG. 7 is a block diagram of an LED light string; and

FIG. 8 is a perspective view of an LED light string.

### DETAILED DESCRIPTION OF THE PREFERRED EMBODIMENT

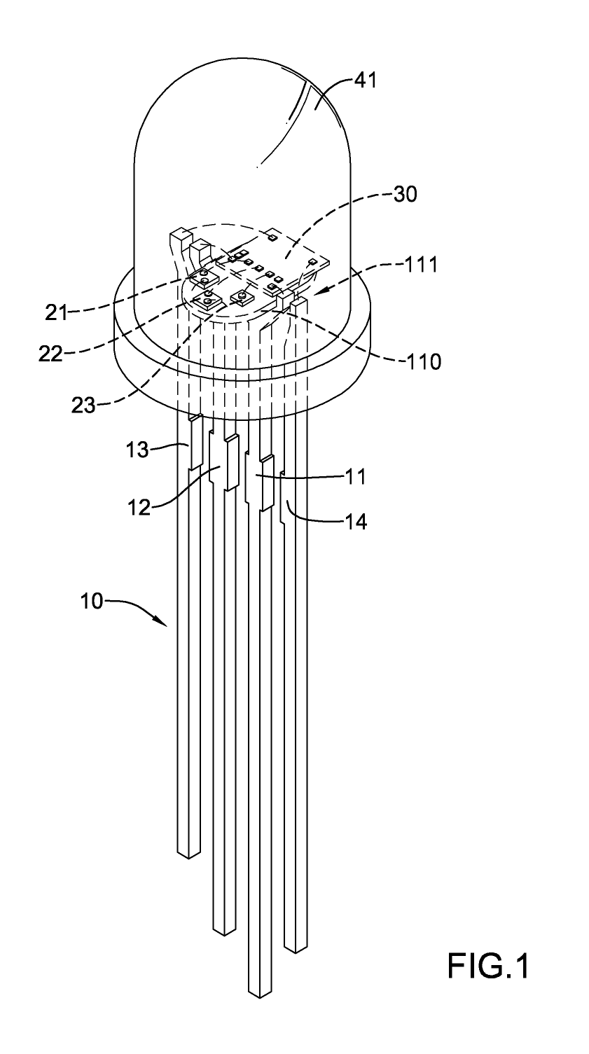

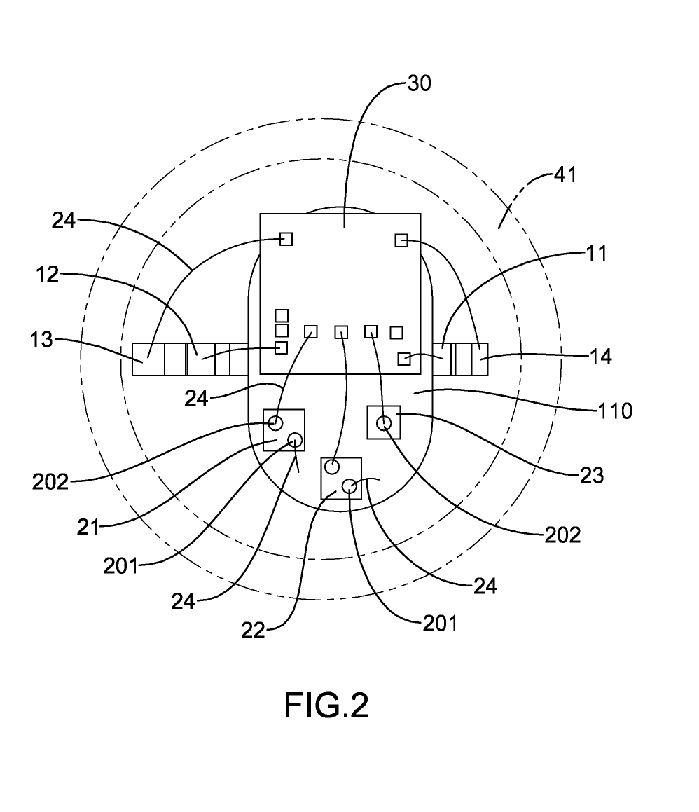

With reference to FIG. 1 and FIG. 2, a first embodiment in accordance with the present invention comprises a pin assembly 10, at least one LED chip 21, 22, 23, a signal controller 30 and a package 41.

The pin assembly 10 has a substrate 110 and multiple pins 11-14. Each pin 11-14 has a top end and the multiple pins 11-14 include a first power pin 11, a second power pin 12, a first signal pin 13 and a second signal pin 14. The substrate 110 is formed on the top end 111 of the first power pin 11.

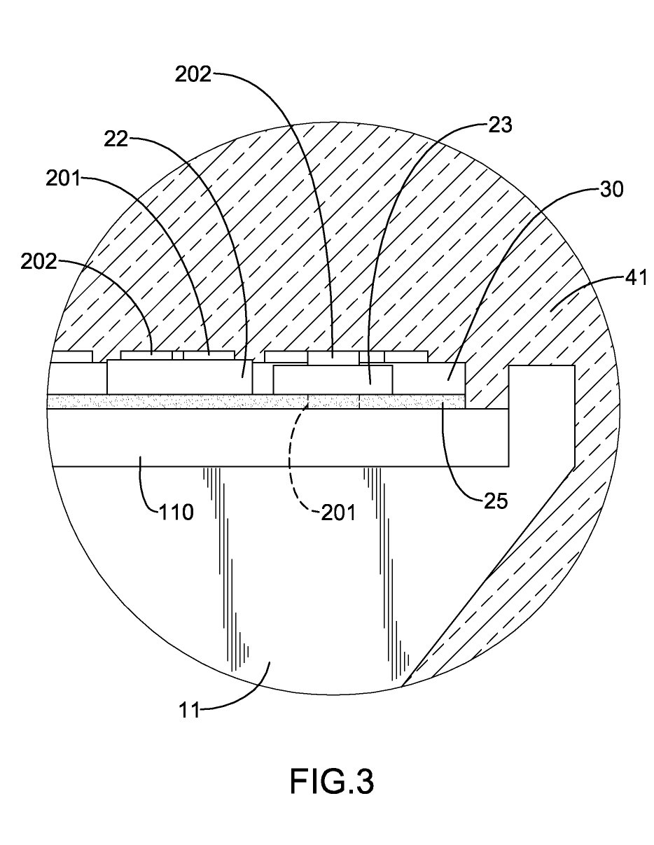

The at least one LED chip 21-23 is mounted on the substrate 110. This embodiment takes a red LED chip 21, a green LED chip 22 and a blue LED chip 23 mounted on the substrate 110 for example. Each LED chip 21-23 has a first pole 201 and a second pole 202. The first pole 201 is opposite to the second pole 202 in polarization. For example, if the first pole 201 is an anode, the second pole 202 will be a cathode. The first pole 201 is electrically connected to the substrate 110 via a conductive wire 24. With reference to FIG. 3, another method to make an electric connection between the LED chips 21-23 and the substrate 110 is illustrated. A conducting adhesive layer 25 is applied on the substrate 110. Taking the blue LED chip 23 for example, the first pole 201 and the second pole 202 are respectively formed on opposite surfaces of the blue LED chip 23. The first pole 201 can be mounted in the conducting adhesive layer 25 to electrically connect to the substrate 110.

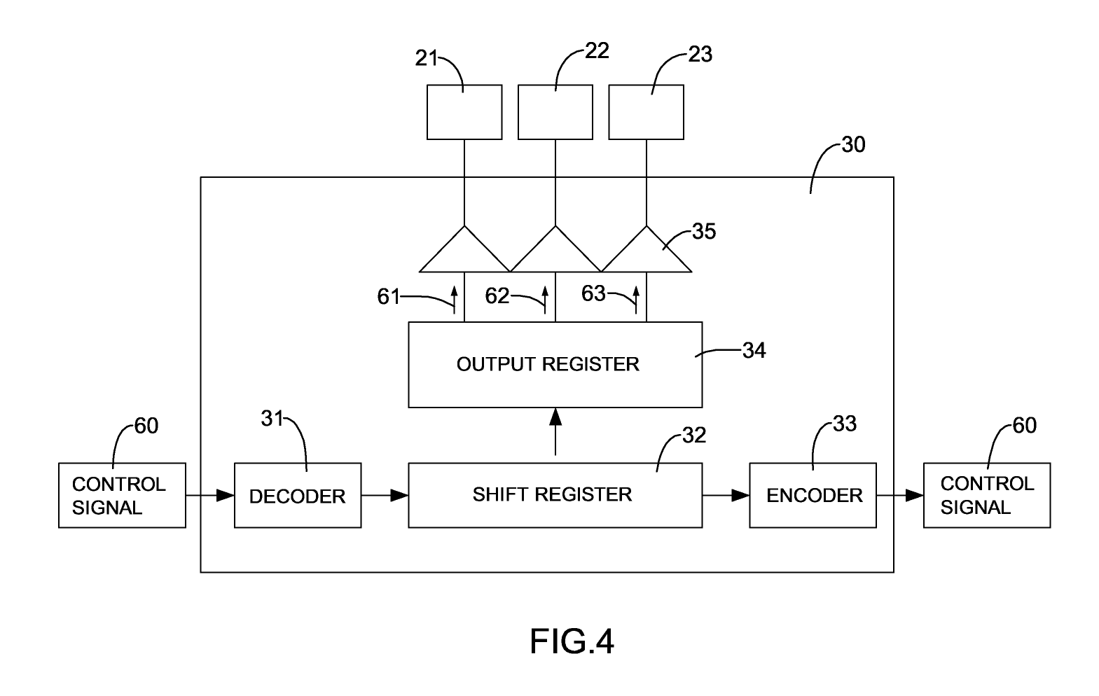

The signal controller 30 is integrated on the substrate 110 and is electrically connected to the first power pin 11, the second power pin 12, the first signal pin 13, the second signal pin 14 and the second poles 202 of the LED chips 21-23 via multiple conductive wires 24. With reference to FIG. 4, the signal controller 30 has a decoder 31, a shift register 32, an encoder 33 and an output register 34.

The decoder 31 is electrically connected to the first signal pin 13 to receive a control signal 60 and decodes the control signal 60 into a red light driving signal, a green light driving signal and a blue light driving signal. The shift register 32 receives and stores the red light, the green light and the blue light driving signals. The encoder 33 is electrically connected to the second signal pin 14 to receive and encode the driving signals of the shift register 32 outputted from the second signal pin 14. The output register 34 is electrically and respectively connected to the LED chips 21-23, wherein multiple amplifiers 35 may be electrically connected between the LED chips 21-23 and the output register 34 respectively. The output register 34 receives the driving signals from the shift register 32 and then correspondingly provides the red light, the green light and the blue light driving signals 61, 62, 63 to the red LED chip 21, the green LED chip 22 and the blue LED chip 23.

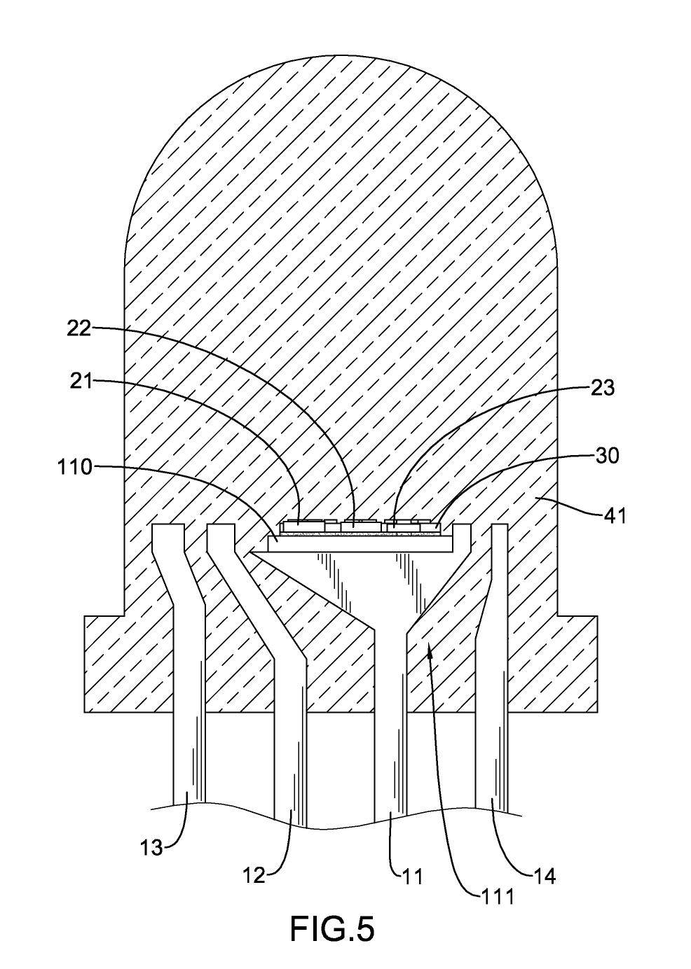

With reference to FIG. 5, the package 41 is formed on the top ends of the pins 11-14 to enclose the LED chips 21-23, the signal controller 30 and the top ends of the pins 11-14.

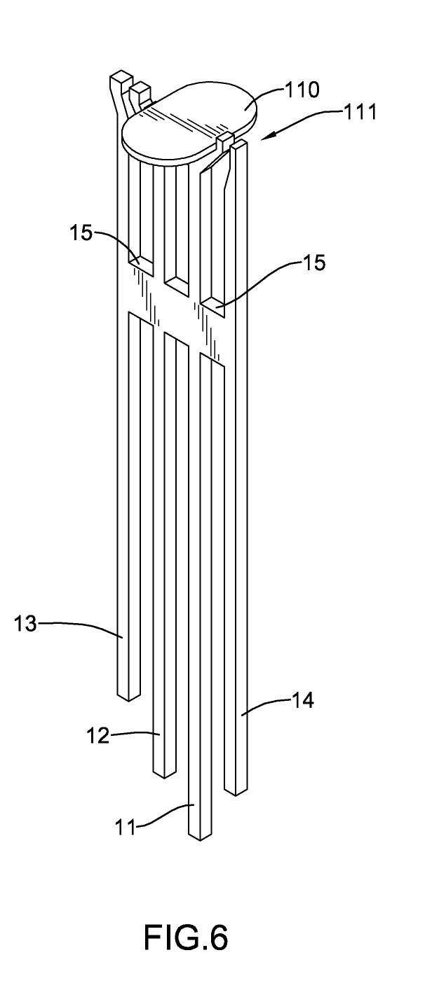

With reference to FIG. 6, an initial structure of the pin assembly 10 is illustrated. Multiple connecting bars 15 are respectively formed between the first power pin 11, the second power pin 12, the first signal pin 13 and the second signal pin 14 to securely connect the pins 11-14. Therefore, it is easy to mount the LED chips 21-23, the signal controller 30 and the conductive wires 24 on the substrate 110. After the package 41 is formed on the substrate 110, the connecting bars 15 will be removed such that the pins 11-14 are totally separated.

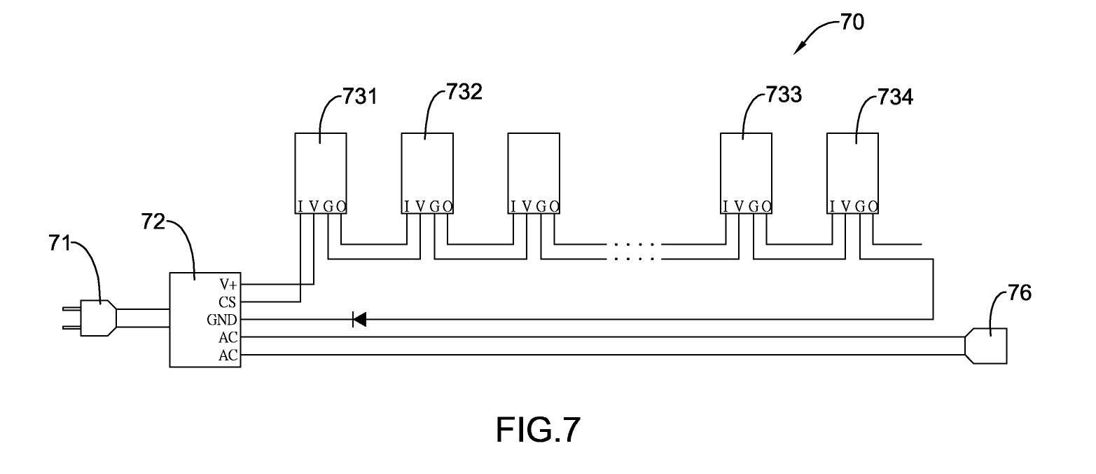

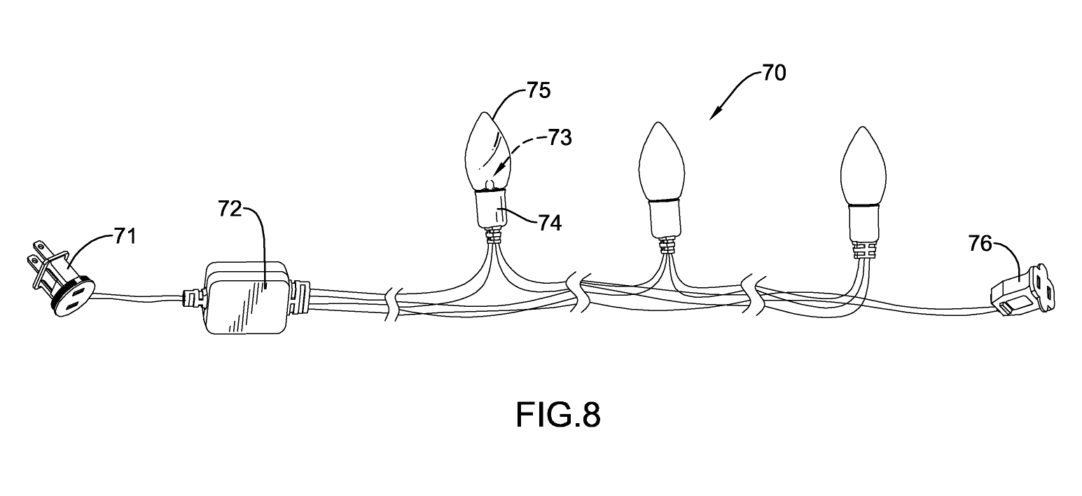

With reference to FIG. 7 and FIG. 8, multiple LED modules in accordance with the present invention can be applied to form an LED light string 70. The LED light string 70 comprises a plug 71, a control device 72 and multiple LED modules 73.

The plug 71 is applied to connect to an AC power source.

The control device 72 is electrically connected to the plug 71 and has a voltage terminal V+, a ground terminal GND and a signal output terminal CS. The voltage terminal V+ outputs a DC voltage. The signal output terminal CS outputs a control signal.

The voltage terminal V+ of the control device 72 is connected to the first power pins V and the second power pins G of the LED modules 73, and the signal output terminal CS of the control device 72 is connected to the first signal pins I and the second signal pins O of the LED modules 73.

For example, with reference to FIG. 7, multiple LED modules 731-734 are connected in series. The first signal pin I and the first power pin V are electrically connected to the signal output terminal CS and the voltage output terminal V+ of the control device 72 respectively. The first signal pin I and the first power pin V of a second LED module 732 are electrically connected to the second signal pin O and the second power pin G of the first LED module 731 respectively, and so on. The first signal pin I and the first power pin V of an nth LED module 734 are electrically connected to the second signal pin O and the second power pin G of an n−1th LED module 733. The second power pin G of the nth LED module 734 is connected to the ground terminal GND of the control device 72.

The LED modules 73 receive the DC voltage generated from the control device 72 as a working voltage. The control signal generated from the control device 72 is outputted to all of the LED modules 73. By decoding the control signal, the signal controller can generate the red light driving signal, the green light driving signal and the blue light driving signal to the LED chips 21-23. Therefore, the LED chips 21-23 can be activated and generate a certain color light.

With reference to FIG. 8, an operation of the LED light string 70 is illustrated. Each LED module 73 is mounted in a base 74 and covered by a shell 75. A tail socket 76 can be mounted on the control device 72 in addition. The tail socket 76 is applied to connect another LED light string 70 or other electric devices.

What is claimed is:

1. An LED light string comprising:
a plug;
a control device electrically connected to the plug and having a voltage terminal and a signal output terminal; and
multiple LED modules, each LED module comprises:
a pin assembly comprising a substrate and multiple pins, wherein each pin has a top end and the multiple pins include
a first power pin, wherein the substrate is formed on the top end of the first power pin;
a second power pin;
a first signal pin; and
a second signal pin;
at least one LED chip mounted on the substrate and electrically connected to the substrate, the LED chip having
a first pole; and
a second pole being opposite to the first pole in polarization;
a signal controller integrated on the substrate and electrically connected to the first power pin, the second power pin, the first signal pin and the second signal pin to provide at least one driving signal to the at least one LED chip; and
a package formed to securely enclose the substrate, the at least one LED chip, the signal controller and the top ends of the multiple pins;
wherein the voltage terminal of the control device is connected to the first power pins and the second power pins of the LED modules, and the signal output terminal of the control device is connected to the first signal pins and the second signal pins of the LED modules.

2. The LED light string as claimed in claim 1, wherein each LED module has a conducting adhesive layer formed on the substrate; and
the first pole of the LED chip is mounted in the conducting adhesive layer to electrically connect to the substrate.

3. The LED light string as claimed in claim 1, wherein the signal controller of each LED module is connected to the first power pin, the second power pin, the first signal pin and the second signal pin via multiple conductive wires.

4. The LED light string as claimed in claim 2, wherein the signal controller of each LED module is connected to the first power pin, the second power pin, the first signal pin and the second signal pin via multiple conductive wires.

5. The LED light string as claimed in claim 1, wherein each LED module is mounted in a base and covered by a shell.

6. The LED light string as claimed in claim 2, wherein each LED module is mounted in a base and covered by a shell.

7. The LED light string as claimed in claim 5, wherein a tail socket is mounted on the control device.

8. The LED light string as claimed in claim 6, wherein a tail socket is mounted on the control device.

9. An LED module with an integrated signal controller comprising:
a pin assembly comprising a substrate and multiple pins, wherein each pin has a top end and the multiple pins include
a first power pin, wherein the substrate is formed on the top end of the first power pin;
a second power pin;
a first signal pin; and
a second signal pin;
at least one LED chip mounted on the substrate and electrically connected to the substrate, the LED chip having
a first pole; and
a second pole being opposite to the first pole in polarization;
a signal controller integrated on the substrate and electrically connected to the first power pin, the second power pin, the first signal pin and the second signal pin to provide at least one driving signal to the at least one LED chip; and
a package formed to securely enclose the substrate, the at least one LED chip, the signal controller and the top ends of the multiple pins.

10. The LED module as claimed in claim 9, wherein
a conducting adhesive layer is formed on the substrate; and
the first pole of the LED chip is mounted in the conducting adhesive layer to electrically connect to the substrate.

11. The LED module as claimed in claim 9, wherein the signal controller is connected to the first power pin, the second power pin, the first signal pin and the second signal pin via multiple conductive wires.

12. The LED module as claimed in claim 10, wherein the signal controller is connected to the first power pin, the second power pin, the first signal pin and the second signal pin via multiple conductive wires.

13. The LED module as claimed in claim 9, wherein the signal controller comprises
a decoder electrically connected to the first signal pin to receive a control signal, and decoding the control signal to generate the at least one driving signal;
a shift register receiving and storing the at least one driving signal;
an output register electrically connected to the at least one LED chip and receiving the at least one driving signal from the shift register to provide the at least one driving signal to the at least one LED chip; and
an encoder electrically connected to the second signal pin to receive and encode the at least one driving signal outputted from the second signal pin.

14. The LED module as claimed in claim 10, wherein the signal controller comprises
a decoder electrically connected to the first signal pin to receive a control signal, and decoding the control signal to generate the at least one driving signal;
a shift register receiving and storing the at least one driving signal;
an output register electrically connected to the at least one LED chip and receiving the at least one driving signal from the shift register to provide the at least one driving signal to the at least one LED chip; and
an encoder electrically connected to the second signal pin to receive and encode the at least one driving signal outputted from the second signal pin.

15. The LED module as claimed in claim 13, wherein at least one amplifier is connected between the at least one LED chip and the output register.

16. The LED module as claimed in claim 14, wherein at least one amplifier is connected between the at least one LED chip and the output register.

17. The LED module as claimed in claim 11, wherein the signal controller comprises
a decoder electrically connected to the first signal pin to receive a control signal, and decoding the control signal to generate the at least one driving signal;
a shift register receiving and storing the at least one driving signal;
an output register electrically connected to the at least one LED chip and receiving the at least one driving signal from the shift register to provide the at least one driving signal to the at least one LED chip; and
an encoder electrically connected to the second signal pin to receive and encode the at least one driving signal outputted from the second signal pin.

18. The LED module as claimed in claim 12, wherein the signal controller comprises
a decoder electrically connected to the first signal pin to receive a control signal, and decoding the control signal to generate the at least one driving signal;
a shift register receiving and storing the at least one driving signal;
an output register electrically connected to the at least one LED chip and receiving the at least one driving signal from the shift register to provide the at least one driving signal to the at least one LED chip; and
an encoder electrically connected to the second signal pin to receive and encode the at least one driving signal outputted from the second signal pin.

19. The LED module as claimed in claim 17, wherein at least one amplifier is connected between the at least one LED chip and the output register.

20. The LED module as claimed in claim 18, wherein at least one amplifier is connected between the at least one LED chip and the output register.
